(19) United States
(12) Patent Application Publication
(10) Pub. No.: US 2012/0317970 A1
(43) Pub. Date: Dec. 20, 2012

(54) Wave power plant

(75) Inventor: Lars Edvardsen, Larvik (NO)

(73) Assignee: INTENTIUM AS, Larvik (NO)

(21) Appl. No.: 13/512,026

(22) PCT Filed: Nov. 26, 2010
(86) PCT No.: PCT/NO10/00436

§ 371 Date: Aug. 24, 2012

(30) Foreign Application Priority Data
Nov. 26, 2009 (NO) 20093423

(51) Int. Cl. F03B 13/22; F03B 15/00

(52) U.S. Cl. 60/496; 60/498

(57) ABSTRACT

The present invention relates to a plant for recovery and conversion of kinetic energy in bodies of water to mechanical or electrical energy. The plant comprises a float (3), a pump, a weight (10), one or more buoyancy regulators (11), an accumulator tank (14) and a turbine (15), where the pump is composed of a double-acting cylinder pump (6, 7), where a stationary outer sleeve (7) is connected with a water anchor (8), to which a water anchor (8) a weight (10) and the buoyancy regulator(s) (11) are connected, where a movable inner sleeve (6) is connected to the float (3), in order thereby to provide a relative movement between the stationary sleeve (7) and the movable inner sleeve (6) when the float (3) is moved in the bodies of water, where the float (3) is connected via mooring lines (4) with a moored surface buoy (2), so that the float (3) is arranged with a long side against incoming waves (5).

The present invention relates to a plant for recovery and conversion of kinetic energy in bodies of water to mechanical or electrical energy.

A number of ideas and methods have been launched for exploitation of wave energy in bodies of water. Till now, however, no one has succeeded in developing installations and/or plants which can compete with conventional solutions for production of electric power in major supply systems. It is, however, conceivable that wave energy could be an interesting energy resource for electricity supply on a small scale to isolated coastal settlements. In Norway, for example, this could be of interest along the west coast, where waves are a fairly regular phenomenon at exposed locations, particularly in winter.

In many countries work and research are being conducted with experimental plants of various types and principles. The common feature of all such trial wave power systems is that several constructional and operational problems have not yet been solved. Some examples of such plants are:
plants in which “tilting floats” are employed, where the energy capture is accomplished by relatively long floats being tilted up and down about their centre of gravity when the waves pass over the floats, thereby driving one or more pump devices, which convert the captured wave energy to electrical energy via hydraulic machinery and a generator.
plants which collect the wave energy at a point (so-called point absorber), where a piston is securely anchored to the seabed. The piston extends up into a cylinder located inside a float on the surface of the sea. The float will be moved up and down with the waves passing over the float. By means of a closed fluid system in the float, the piston movement creates a pressure which is utilised to drive a generator for converting the energy (the hydrostatic pressure) to electrical energy. By controlling valves in the closed fluid system, the float's movement relative to the waves can be delayed, thereby enabling the energy to be taken from a wave front, where this wave front has a width which is substantially wider than the float's physical width.
plants where sea water is pumped into a cylinder extending down into the water from the bottom of a float. A piston inside the cylinder is connected via a rod to the seabed, where the float's oscillation in the waves will pump sea water into the cylinder and on to a pipe system. Valves of a special design cause water to be taken up both during ascending motion and descending motion. The conversion to electrical energy takes place inside the float before the sea water is again pumped out to sea. Here the sea water may also be passed through the piston rod, via a pipeline on the seabed, to an elevated basin on shore where it is employed for power production.
plants which are directed towards incoming waves by means of so-called wave lenses (large elements made of concrete or the like). These are anchored by a line under the surface of the sea at set distances apart and parallel to prevailing wave fronts. The wave lenses will then change the waves' direction, thereby enabling them to concentrate the wave energy in towards one point. In this concentrated point the wave height increases steeply, and it is here that a so-called point absorber can be placed.

As an example of the prior art we refer to U.S. Pat. No. 581,067. A wave power station is described here, where the wave power station comprises a surface buoy which is connected via a mast to one or more double-acting pumps. A weight, which is connected to the mast at the opposite end of the surface buoy, will increase the wave power station's stability, while a water anchor will hold the wave power station at the desired depth.

Variations in the waves' oscillations result in many practical and economic problems with regard to the conversion to electrical energy; the plant's total efficiency becomes lower, the plant is subjected to severe stresses in extreme wave conditions, etc.

Consequently, it is an object of the present invention to provide a plant for recovery and conversion of kinetic energy in bodies of water, where the plant is subjected to less mechanical stress, is easier to regulate with regard to energy production and has a simpler structural design than the prior art.

These objects are achieved with a device according to the following claims.

The present invention relates to a plant for recovery and conversion of kinetic energy in bodies of water to mechanical or electrical energy, where the plant comprises a float, a pump, a weight, an accumulator tank and a water turbine, where the pump is in the form of a double-acting cylinder pump, consisting of a stationary outer (lower) sleeve and a movable inner (upper) sleeve. When the plant is not influenced by waves, the double-acting cylinder pump will be substantially arranged vertically in the water. In order to keep the double-acting cylinder pump at a desired depth in the body of water, the stationary outer sleeve of the double-acting cylinder pump is connected at one end to a water anchor or a reaction plate. In addition, a weight is connected to the water anchor or the reaction plate via a number of lines, chains or the like, with the result that the influence of the waves on the stationary outer sleeve and the water anchor is reduced.

The double-acting cylinder pump's movable inner sleeve is connected to the float, in order thereby to provide a relative movement between the stationary outer sleeve and the movable inner sleeve of the double-acting cylinder pump as a result of the movement of the float up and down in the body of water. The connection between the movable inner sleeve and the float is of such a nature that it permits a certain relative movement between the inner sleeve and the float.

The float is connected to a surface buoy via at least one mooring cable or similar mooring arrangement. The number of mooring cables employed to connect the elongated float to the surface buoy will be dependent on the length of the float, the stresses to which the plant is subjected, etc. The surface buoy will be connected via a mooring cable, chain, wire or similar mooring arrangement to one or more mooring devices arranged on the seabed.

In a preferred embodiment of the present invention the water anchor is designed to be able to be ballasted/deballasted. When the plant for recovery and conversion of the kinetic energy in bodies of water is transported out to the location where it is to be deployed or installed, the water anchor will not be ballasted. This means that the plant can be towed out in a floating state to the position where the plant has to be installed. However, when the plant is arranged at the location, the water anchor will be ballasted, giving the water anchor negative buoyancy. The water anchor will then be used for stabilising the plant in the body of water, in addition to which there will be an increase in the water anchor's inertia.

It should also be understood, however, that the water anchor may be actively employed (by means of ballasting/deballasting) for positioning the plant in the body of water, both during transport and also when the plant for recovery and conversion of kinetic energy in bodies of water is installed. The water anchor will then comprise a pump and valve arrangement.

In an embodiment of the present invention the water anchor may also be designed with an upright edge or wall round its outer periphery (upper and/or lower top surface of the water anchor), with the result that a volume of water is “captured” within the area defined by the water anchor's upper and/or lower surface and the upright edge or wall. This “additional volume of water” will increase the water anchor's inertia, thereby damping the heaving motion of the water anchor (and thereby also of the plant).

Since the water anchor is employed for stabilising the plant at a desired depth in the bodies of water, the water anchor is designed as a closed unit or structure, containing water, thereby increasing its inertia. The water anchor is preferably in the form of a circular, closed cylinder provided with a large surface area. It should be understood, however, that the water anchor may be of any closed shape whatever.

In an alternative embodiment of the present invention the water anchor may also be composed of one or more plates (so-called reaction plates), these being connected in a similar manner to the stationary, outer sleeve. If several plates are employed, these will be arranged spaced above one another in such a manner that volumes of water which are “captured” between the plates will follow the double-acting cylinder pump's movement in the volumes of water. This will damp the plant's heaving motion.

The water anchor or the plate(s) are preferably connected to the stationary, outer sleeve via a universal joint.

The device for energy capture may be composed of one or more accumulator tanks and/or water turbines, where in a preferred embodiment of the present invention the device for energy capture is arranged on a separate floating body which is connected to the float. The connection between the floating body and the float will be of such a nature that the floating body will be able to move in rolling and pitching, but be restricted in its yawing motion, with the result that the floating body will follow the float's motion relative to wind and weather. In an alternative embodiment of the present invention it will also be possible to exploit the relative motion between the floating body and the float.

It should be understood, however, that the floating body which comprises the device for energy capture may also be connected to the outer, stationary part of the double-acting cylinder pump.

The plant according to the present invention also comprises one or more buoyancy regulators, where the buoyancy regulators are connected via a frame system to the stationary outer sleeve. The buoyancy regulators will be open at one end and may be of any shape whatever, for example a cylinder with a spherical or paraboloidal bottom. The open end of the buoyancy regulators will thus face downwards in the bodies of water, thereby enabling the buoyancy regulators to collect a quantity of air in their internal volume. The buoyancy regulators are then connected to a pipe and valve arrangement. By regulating the amount of air collected in the buoyancy regulators, the plant's position in the water, together with the water anchor and the weight, can be regulated.

The plant's double-acting pump is composed of an outer, stationary sleeve (which is connected to the water anchor and the weight) and an inner, movable sleeve (which is connected to the float). This construction permits the double-acting cylinder pump to be extended when the float moves on the crest of a wave and compressed when the float moves in the trough of a wave. The double-acting cylinder pump is provided with a lower water intake which is connected with a lower pump chamber, and an upper water intake, which is connected with an inner pump chamber via an upper piston valve and a pump chamber, where the inner pump chamber is further connected to the device for energy capture via a transmission device.

In a preferred embodiment of the present invention the lower and upper water intakes are in the form of a funnel, where the narrowest end of the funnel is connected in a suitable fashion to the outer stationary sleeve of the double-acting cylinder pump. The widest end of the funnel will then have an internal diameter which is larger than the stationary outer sleeve's outer circumference. The water intakes will further be designed to avoid major flow loss (friction). The lower and upper water intakes may be of identical design.

It should be understood, however, that the water intakes may be of different design, that the lower and upper water intakes may be of the same or different design, that several water intakes may be provided over the length of the double-acting cylinder pump, etc., where a person skilled in the art will know how this should be done.

In a preferred embodiment of the present invention water (fresh water or sea water) may be used as flow medium when the plant is designed as an “open” system. It should be understood, however, that the plant may also be designed or constructed as a “closed” system, in which case fresh water will be used as flow medium. The term open system in the present application refers to a system where flow medium is sucked in through at least one intake which is connected to the pump and is pumped out through at least one outlet after the energy capture. The term closed system in the present application refers to a system where flow medium circulates in a “continuous” and closed loop across the pump after the energy capture, without flow medium being pumped out of the system.

It should be understood, moreover, that air may also be used as flow medium. However, this may entail the double-acting cylinder pump having to be turned “upside down”, whereupon the pump will then suck in air or fresh water from the “closed” system when the float moves in the waves. The double-acting cylinder pump's mode of operation remains the same, but with certain modifications with regard to intake, energy capture, etc. A person skilled in the art will know how this may be done, and it is therefore not further described here.

It should also be understood that the double-acting pump may be replaced by a power-generating linear generator. The principle of float, water anchor and buoyancy regulator remains the same, but with the difference that the energy absorption is accomplished by means of a linear generator instead of a pump. In this case the floating body with accumulator tank(s) and turbine(s) is removed and replaced by electrical engineering. Since a person skilled in the art will know how this can be done, it is not further described here.

A non-limiting description will now be given of embodiments of the present invention with reference to the accompanying drawings, in which

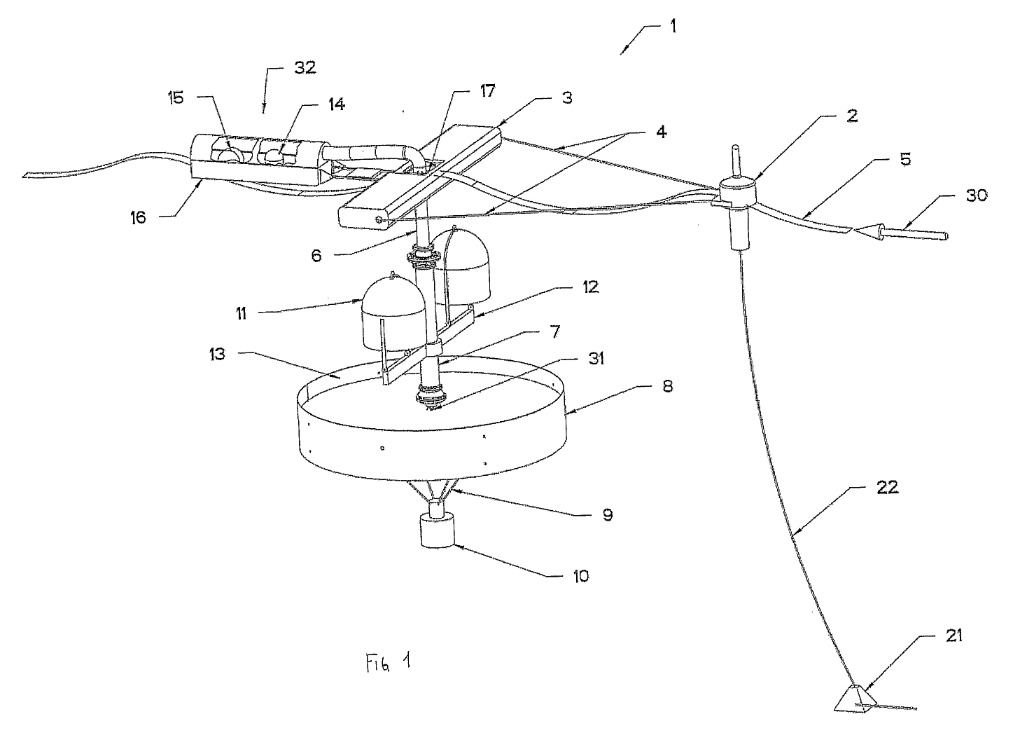

FIG. 1 illustrates main elements in a plant for recovery and conversion of kinetic energy in bodies of water according to an embodiment of the present invention,

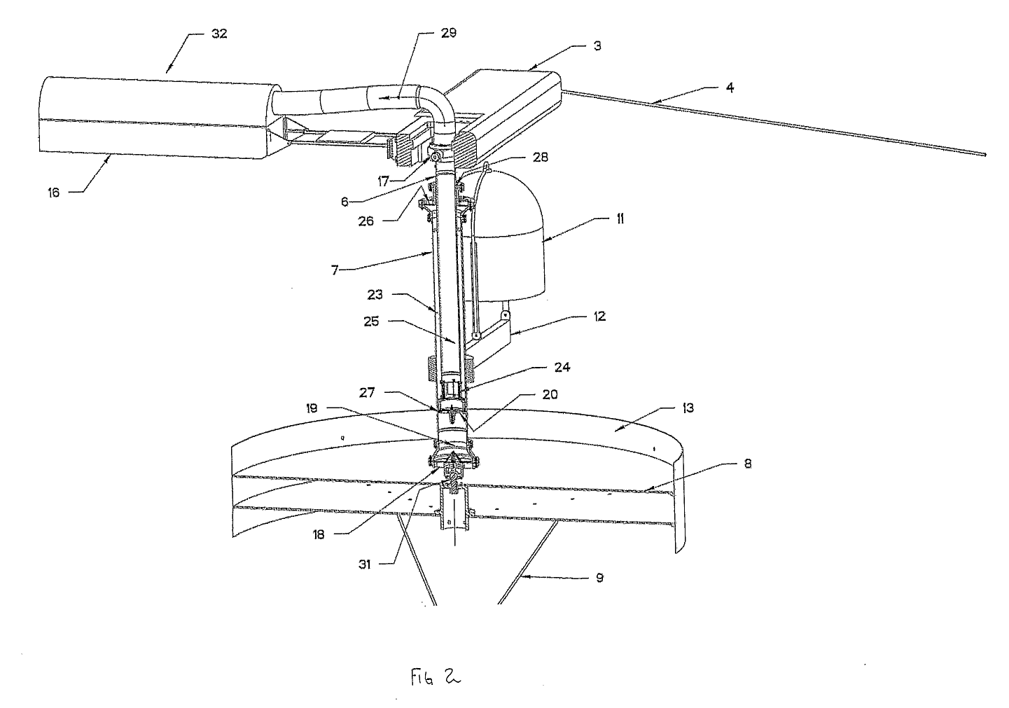

FIG. 2 is a cross section of a cylinder pump, a water anchor and a float in the plant according to FIG. 1, and

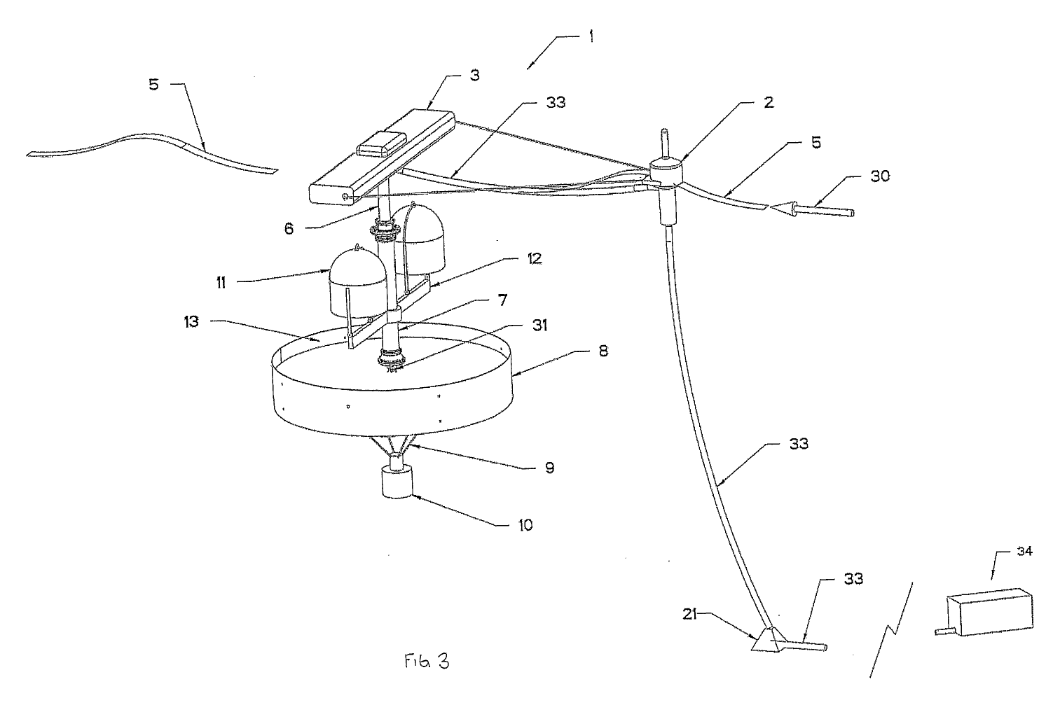

FIG. 3 illustrates a second embodiment of a plant for recovery and conversion of kinetic energy in bodies of water according to the present invention.

FIG. 1 illustrates a preferred embodiment of a plant 1 for recovery and conversion of kinetic energy in bodies of water offshore according to the present invention. The plant 1 for recovery and conversion of kinetic energy in bodies of water comprises a moored surface buoy 2, to which surface buoy 2 an elongated float 3 is connected via two mooring cables 4. A person skilled in the art will appreciate, however, that the number of mooring cables 4 may vary according to the plant's 1 design and/or size, so that both a smaller and a greater number of mooring cables 4 may be employed for connecting the surface buoy 2 and the elongated float 3.

The surface buoy 2 is connected to a mooring device 21 located on the seabed via a mooring cable 22. A person skilled in the art will understand, however, that the number of mooring cables 22 may vary according to the plant's 1 design and/or size, so that a greater number of mooring cables 22 may be employed for connecting the surface buoy 2 to mooring devices 21 located on the seabed.

The design of the surface buoy 2 will permit the float 3 to rotate about the surface buoy's 2 longitudinal axis, with the result that the float 3 is arranged with its long side facing incoming waves 5, normally on the waves' (the wave front's) 5 direction of travel. This will enable the plant's efficiency to be increased. The float 3 is further connected to a pump arrangement, where the pump arrangement is composed of a stationary outer (lower) sleeve 7 and a movable inner (upper) sleeve 6, where the stationary outer sleeve 7 and the movable inner sleeve 6 will function as a double-acting cylinder pump 6, 7. The stationary outer sleeve 7 is furthermore connected at one end to a buoyancy-regulated water anchor or reaction plate 8. The water anchor 8 is further connected to a weight 10 via a number of lines 9.

The water anchor 8 will be designed to have a large surface area, with the result that the water anchor 8 has maximum braking effect on the upward or downward motion to which the stationary outer sleeve 7 is subjected when the plant 1 is moving in waves (heave). In addition, the weight 10 will ensure that the plant 1 is substantially held in its vertical position in the water.

One or more buoyancy regulators 11 are also connected via a frame system 12 to the stationary outer sleeve 7 of the double-acting cylinder pump 6, 7. In FIG. 1 the buoyancy regulators 11 are in the form of a cylinder with a partially spherical bottom and arranged with their open side facing downwards in the water, in order thereby to form an air pocket in the buoyancy regulators 11. The buoyancy regulators 11 are connected to one or more air supply lines and/or valve devices (not shown), thereby enabling the volume of air located in the buoyancy regulators 11 to be regulated. The regulation can then be controlled by an ordinary electronic regulation loop (not shown), which will be well known to a person skilled in the art. The result is that the buoyancy regulators 11 act as a “lifting balloon” for the stationary outer sleeve 7, the water anchor 8 and the weight 10, thus permitting them to be positioned at a desired depth and subsequently neutralised with respect to buoyancy. A positioning operation of this kind will be conducted with regard to the requirement for the double-acting cylinder pump 6, 7 to operate about its central position, which will increase the plant's 1 efficiency. Thus by means of the above arrangement the stationary outer sleeve 7, the water anchor 8 and the weight 10 have been made “independent” of the plant's 1 mooring on the seabed.

The water anchor 8 which is buoyancy-regulated, will be able to be filled with/emptied of sea water by means of a pump, pipe and valve arrangement (not shown), so that, by being filled with water, the water anchor 8 increases its inertia and thereby helps to stabilise the water anchor 8, the outer stationary sleeve 7 and the weight 10 in the desired position.

In the illustrated embodiment the water anchor 8 is also designed with a raised edge or wall 13 round its outer periphery (round the upper and/or lower surface), with the result that an “additional volume of water” will follow the water anchor 8 during the water anchor's upward and downward motion. This “additional volume of water” will further increase the water anchor's 8 inertia, thereby damping the water anchor's 8 heave motion.

When the plant 1 moves in waves, the elongated float 3 and the movable inner sleeve 6 will move relative to the stationary outer sleeve 7, the water anchor 8 and the weight 10. On account of the double-acting pump 6, 7, this causes sea water to be pumped to a device for energy capture 32, which comprises amongst other things an accumulator tank 14 and a water turbine 15. The sea water is therefore first pumped to the accumulator tank 14 and then to the water turbine 15. The accumulator tank 14 and the water turbine 15 are arranged on a floating body 16, where the floating body 16 is connected in a suitable fashion to the elongated float 3 on the opposite side to the incoming waves 5 against the elongated float 3.

The connection between the floating body 16 and the rest of the plant 1 via the elongated float 3 will be of such a nature that the floating body 16 will have the freedom to be able to pitch and roll, while the floating body's 16 yawing motion is reduced. This will result in the floating body 16 “following” the elongated float's 3 movement relative to wind and weather, while at the same time moving independently relative to the elongated float's 3 heave motion.

A mooring cable or cables 4, 22 will furthermore be provided to permit electric power and/or signals to be transmitted to one or more of the plant's 1 elements. Since a person skilled in the art knows how this should be done, it is not further described here.

The elongated float 3 comprises an attachment device 17 for the movable inner sleeve 6 in the double-acting cylinder pump 6, 7, where the attachment device 17 will permit the movable inner sleeve 6 to be moved in several planes (roll, pitch, yaw, etc.) relative to the elongated float 3. This will prevent the various elements of the plant 1 being subjected to unnecessary stress.

FIG. 2 illustrates in greater detail the design of the double-acting piston pump 6, 7, as well as how the water anchor 8 is designed. The double-acting piston pump 6, 7 comprises a stationary outer sleeve 7, where the stationary outer sleeve 7 is connected to the water anchor 8 via a universal joint 31, thereby permitting the double-acting piston pump 6, 7 a pendulum movement and/or rotating movement relative to the water anchor 8 when the elongated float 3 is moved in the waves.

The movable inner sleeve 6 is as described above connected to the elongated float 3 via the attachment device 17.

When the elongated float 3 is moved upwards by a wave crest, the double-acting cylinder pump 6, 7 is extended, and when the elongated float 3 is moved downwards by a wave trough, the double-acting cylinder pump 6, 7 is compressed.

The double-acting cylinder pump's 6, 7 mode of operation will now be explained in more detail. The double-acting cylinder pump 6, 7 will pump water both when it is extended and when it is compressed. When the double-acting cylinder pump 6, 7 is extended, water will be sucked in through a lower water intake 18 and into a lower pump chamber 19. At the same time water which is already located in an upper pump chamber 23, is pressed through an upper piston valve 24 into an inner pump chamber 25.

The water from the inner pump chamber 25 is then pumped out through a transfer device 29 (a flexible pipe or the like) and on out to the device for energy capture 32, which comprises at least one accumulator tank 14 and at least one water turbine 15, which are mounted on the floating body 16. This occurs when the elongated float 3 has moved on account of a wave crest. When the double-acting cylinder pump 6, 7 is compressed due to the fact that the elongated float 3 is moving in a wave trough, water will be sucked in through an upper water intake 26 and into the upper pump chamber 23. At the same time water, which is already located in the lower pump chamber 19, is pressed through a lower piston valve 20 into the inner pump chamber 25. The pump 29 will then pump the water out of the inner pump chamber 25 and out to the accumulator 14 in the energy capture device.

As can be seen in the figures, the lower and upper water intakes 18, 26 are funnel-shaped, where a widest part of the funnel has an internal diameter which is larger than the stationary outer sleeve's 7 diameter.

One or more seals 27 are further provided between the piston and the cylinder's inner wall to prevent water, which is sucked into the double-acting cylinder pump 6, 7, from flowing between the upper and lower pump chambers 23, 19. In the same way, a seal 28 will be provided between the upper internal cylinder and the inner wall to prevent water from flowing out from the upper pump chamber 23.

FIG. 3 illustrates an alternative embodiment of the present invention, where a number of plants 1 for recovery and conversion of kinetic energy in bodies of water (only one plant is depicted) by means of a pressurized water network are connected to a common device for energy capture 34. The device for energy capture 34 is placed at a remote location, for example on shore, on a floating body or submerged below water. The plants 1 for recovery and conversion of kinetic energy in bodies of water will then be connected via one or more pipes 33 to the energy capture device 34, which for example is located on shore, with the result that water which is pumped through the double-acting cylinder pump 6, 7 is instead passed through the pipe/pipes 33 and into the energy capture device 34. In this alternative embodiment the double-acting cylinder pump may be turned “upside down” (relative to what is described under FIGS. 1 and 2).

The invention has now been explained by means of a preferred embodiment. Only elements connected with the invention have been described and a person skilled in the art will appreciate that in the present plant several smaller floats may be employed, the water anchor may have any form whatever, several plants may be interconnected, the flow medium may be water (fresh water/sea water) or air, the plant may be designed as a “closed” or “open” circuit, the double-acting cylinder pump may be turned upside down, etc.

1. A plant (1) for recovery and conversion of kinetic energy in bodies of water to mechanical or electrical energy, comprising a float (3), a pump, a weight (10), an accumulator tank (14) and a turbine (15),
characterised in that the pump is a double-acting cylinder pump (6, 7), where a stationary outer sleeve (7) is connected with a water anchor (8), to which water anchor (8) the weight (10) is connected, where a movable inner sleeve (6) is connected to the float (3), in order thereby to provide a relative movement between the stationary sleeve (7) and the movable sleeve (6) when the float (3) is moved in the bodies of water, where the float (3) is connected with a moored surface buoy (2) via a mooring cable (4), so that the float (3) is arranged with a long side against incoming waves (5).

2. A plant according to claim 1,
characterised in that the float (3) is connected to the surface buoy (2) via at least two mooring cables (4), where the surface buoy (2) is further connected via at least one mooring cable (22) to a mooring device (21) on the seabed, which mooring cables (4, 22) are designed to be able to transmit electric power, energy and/or signals from the plant (1).

3. A plant according to claim 1,
characterised in that the movable inner sleeve (6) is connected to the float (3) via an attachment device (17), while the stationary outer sleeve (7) is connected to the water anchor (8) via a universal joint (31).

4. A plant according to claim 1,
characterised in that at least one buoyancy regulator (11) is connected via a frame system (12) to the stationary outer sleeve (7), which in turn is connected to the water anchor (8).

5. A plant according to claim 1,
characterised in that the double-acting cylinder pump (6, 7) is provided with a lower water intake (18), a lower pump chamber (19), an upper piston valve (24), an inner pump chamber (25) and an upper pump chamber (23).

6. A plant according to claim 1,
characterised in that a transfer device (29) is connected via one end with an upper part of the cylinder pump (6, 7) and connected via its opposite end with the device for energy capture (32).

7. A plant according to claim 6,
characterised in that the device for energy capture (32) comprises at least one accumulator tank (14) and at least one turbine (15).

8. A plant according to claim 1,
characterised in that the device for energy capture (32) is located on a floating body (16), which floating body (16) is connected to the float (3).

9. A plant according to claim 8,
characterised in that the floating body (16) is connected to the float (3) via a flexible coupling which permits the floating body's (16) pitching and rolling motion, but restricts lateral motion.

10. A plant according to claim 1,
characterised in that the water anchor (8) is composed of a closed structure, provided with a valve arrangement.

11. A plant according to claim 1 or 10,
characterised in that the water anchor (8) is provided at its top and/or bottom surface with an edge or wall, which extends round the water anchor's (8) outer periphery.
